(19) United States
(12) Patent Application Publication
(10) Pub. No.: US 2006/0039387 A1
(43) Pub. Date: Feb. 23, 2006

(54) Frame generator

(75) Inventor: Hideki Hayashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/201,303

(22) Filed: Aug. 11, 2005

(30) Foreign Application Priority Data
Aug. 23, 2004 (JP) 2004-242527

(51) Int. Cl. H04L 12/28

(52) U.S. Cl. 370/401

(57) ABSTRACT

An object of the present invention is to provide a frame generator in which no variable range of the field of a transmission frame required to measure a network is restricted by the capacity of a memory. The invention is a frame generator for outputting a transmission frame generated on the basis of a field value of a frame to a network, and comprising: a memory for storing a reference frame as a first frame of the transmission frame; a field arithmetic section for outputting an arbitrary field value of the input frame and comparing this field value and a corresponding field value of the reference frame and calculating the difference between these field values; a check sum arithmetic section for calculating a check sum generated by the difference; and a field control section for inputting the arbitrary field value and the check sum thereto and determining into which place of the transmission frame the arbitrary field value and the check sum are inserted.

### BACKGROUND OF THE INVENTION

1. Field of the Invention

The present invention relates to a frame generator utilized in the measurement of network performance such as a throughput measurement, a delay time measurement, etc., and particularly relates to a frame generator in which no variable range of the field of a transmission frame required in the measurement of the network is restricted by the capacity of a memory.

2. Description of Related Art

The frame generator utilized in the measurement of the network performance such as the “throughput measurement”, the “delay time measurement”, etc. is generally required to develop and manufacture a network device such as a media converter, LAN, a switch, a router, a transmission device, etc. In such a frame generator, it is necessary to arbitrarily convert the frame, etc. and output the frame to the network. A device as shown in JP-A-2003-198589 is known as a literature of the frame generator for arbitrarily converting the frame, etc.

The conventional frame generator adopts a system in which the entire frame generated by firmware is sequentially stored to the memory and is outputted to the network in conformed timing. Such a conventional frame generator will next be explained.

FIG. 1 shows a constructional example of the conventional frame generator. FIG. 2 shows a constructional example of the frame of IPv4. In FIG. 1, the firmware 3 is control software for arbitrarily varying a field value and generating the frame. The frame is generated by arbitrarily varying the field values of an IP address (a transmission source IP address and a transmission destination IP address) and a TOS field of FIG. 2(α), a MAC address of FIG. 2(β), etc.

Here, the field of the IP address is an artificial header of a TCP/UDP header. Accordingly, when the field value of the IP address is changed, a TCP/UDP header check sum value is also changed.

The IP check sum of FIG. 2(α), the TCP check sum of FIG. 2(γ) and the UDP check sum of FIG. 2(δ) are used to check whether there is no error in transfer of the frame. For example, when the IP address is increased by one bit from “0.0.0.128” to “0.0.0.129” in decimal notation, there is a function for reducing this IP header check sum by one bit since all values within the header are calculated as complements of 1 in a 16-bit unit and the complement of 1 of this calculating value is set to a check sum.

In FIG. 1, the frame generator 10 has a memory 1 and a frame transmitting section 2. The memory 1 stores the entire frame, but the number of stored frames depends on the memory capacity of the memory 1. The frame transmitting section 2 outputs the transmission frame stored to the memory 1 in conformity with transmission timing.

Next, the operation of such a frame generator 10 will be explained. Here, the explanation is made with respect to a case in which the transmission destination IP address of FIG. 2(α) among the field values of the frame is varied as in “0.0.0.0” (starting IP address), 0.0.0.1, - - - , 0.0.0.255 (terminal IP address) in the decimal notation.

First, a base frame is outputted from the firmware 3 to the frame generator 10. In this case, the firmware 3 arithmetically calculates the check sum of the base frame and writes this check sum to the memory 1. Here, the base frame is a frame into which the starting IP address “0.0.0.0.” of the field is inserted.

Next, the firmware 3 varies the IP address of the frame as in “0.0.0.1”, “0.0.0.2”, - - - , “0.0.0.255” (terminal IP address) in the decimal notation, and the same value is inserted into the other field values, and the frame made by recalculating the IP header check sum is outputted to the frame generator 10 and is written to the memory 1.

The frame transmitting section 2 reads data from the memory 1 every one frame in accordance with a signal of the transmission starting outputted from the firmware 3, and outputs the transmission frame to the network.

In accordance with such a method for sequentially storing the entire frame to the memory 1, these frames can be collectively displayed in the frame generator 10 by the capacity of the memory 1.

However, the entire frame must be also written to the memory 1 when one portion of the field of the IP address, etc. is varied in the firmware 3. Accordingly, a problem exists in that the variable range of the field able to be changed by the firmware 3 is limited by the memory capacity of the memory 1.

Further, the variable value can be designated only every field specified by the frame format as shown in FIG. 2.

Further, in the case of the header in which the field of the frame has the check sum field as in IP and TCP/UDP, it is necessary to arithmetically calculate the check sum. However, when all these arithmetic calculations are made by the firmware 3, a problem exists in that the arithmetic time is lengthened. On the other hand, when the arithmetic calculation is made by the frame generator 10, the entire frame must be stored every frame. Accordingly, there is a problem of an increase in a circuit scale.

An object of the invention is to provide a frame generator in which the variable range of the field of a transmission frame required to measure the network is not restricted by the capacity of the memory.

### SUMMARY OF THE INVENTION

An object of the invention is to provide a frame generator in which no variable range of the field of a transmission frame required to measure a network is restricted by the capacity of a memory.

The invention is a frame generator for outputting a transmission frame generated on the basis of a field value of a frame to a network, and comprising:
a memory for storing a reference frame as a first frame of the transmission frame;
a field arithmetic section for outputting an arbitrary field value of the input frame and comparing this field value and a corresponding field value of the reference frame and calculating the difference between these field values;
a check sum arithmetic section for calculating a check sum generated by the difference; and
a field control section for inputting the arbitrary field value and the check sum thereto and determining into which place of the transmission frame the arbitrary field value and the check sum are inserted.

### BRIEF DESCRIPTION OF THE DRAWINGS

FIG. 1 shows a constructional example showing one embodiment of a conventional frame generator.

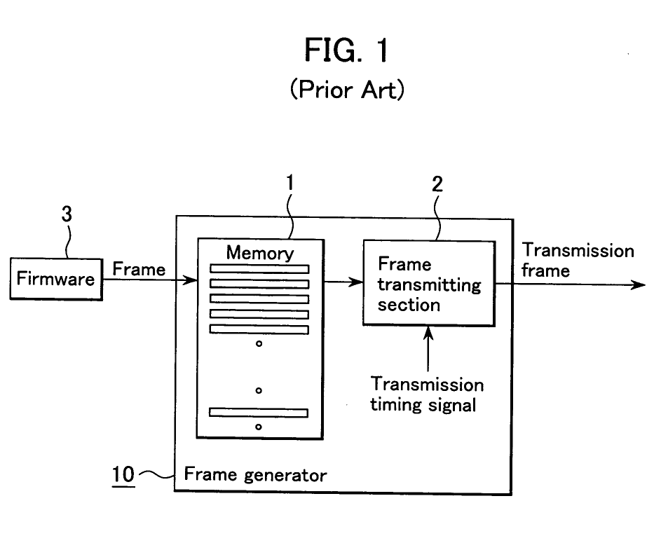

FIG. 2 shows a constructional example of a frame of IPv4.

FIG. 3 shows a constructional example showing one embodiment of a frame generator 100 of the invention.

FIG. 4 is a detailed explanatory view of a field arithmetic section 120, a check sum arithmetic section 130 and a field arithmetic section 140 of FIG. 3.

FIG. 5 is a detailed explanatory view of the check sum arithmetic section 130 of FIG. 3.

### DESCRIPTION OF THE PREFERRED EMBODIMENTS

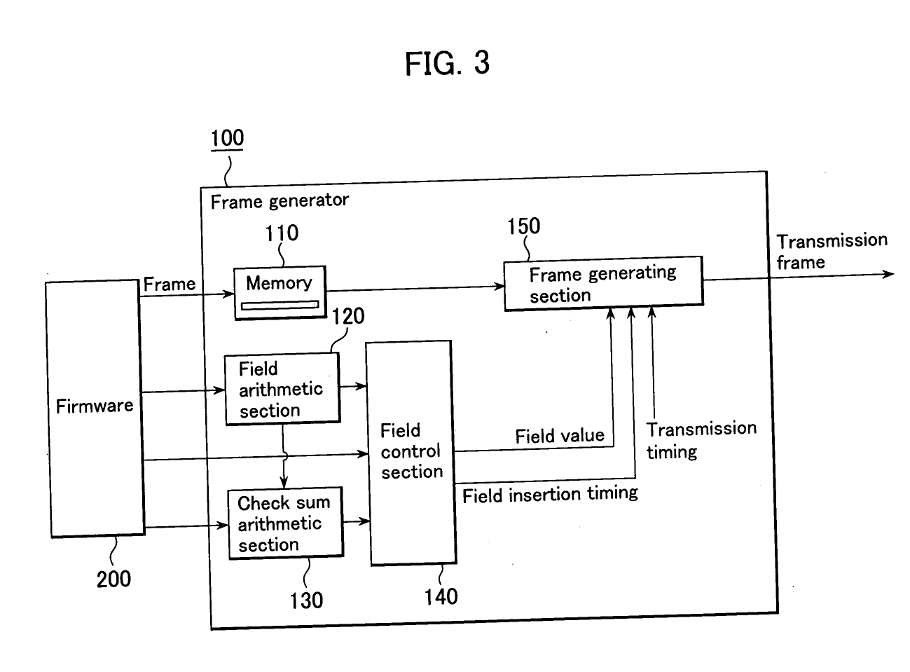

The embodiment mode of the invention of FIG. 3 will next be explained. FIG. 3 shows a constructional example showing one embodiment of a frame generator of the invention. The construction and operation of the frame generator in the invention will be schematically explained by using FIG. 3.

In FIG. 3, the frame generator 100 has a memory 110, a field arithmetic section 120, a check sum arithmetic section 130, a field control section 140 and a frame generating section 150. The memory 110 stores a reference frame of a transmission frame.

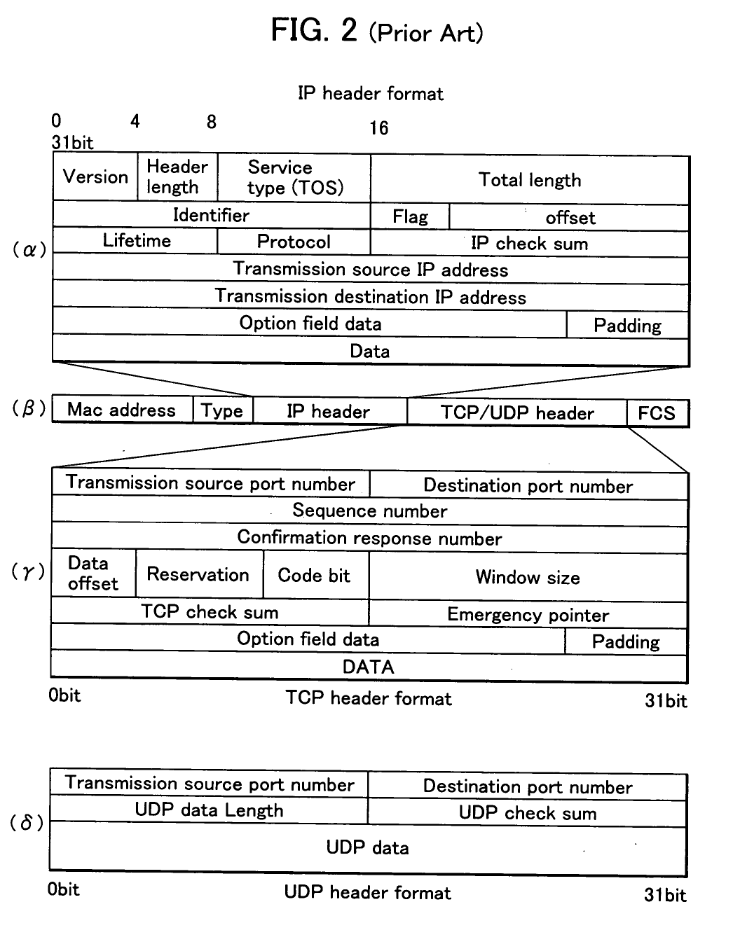

Firmware 200 is control software for generating the frame, and generates the frame by arbitrarily varying the field values of a MAC address, an IP address, a TOS field, etc. of the frame of FIG. 2.

The operation of the frame generator of FIG. 3 will next be explained. Here, the explanation is made with respect to a case in which a transmission destination IP address of FIG. 2(α) among the field values of the frame is sequentially changed from e.g., “0.0.0.0” (starting IP address) to “0.0.0.1”, - - - in decimal notation. The firmware 200 outputs a first frame, i.e., the frame of “0.0.0.0” with respect to the IP address to the frame generator 100.

The memory 110 of the frame generator 100 stores this entire first frame inputted from the firmware 200. The field arithmetic section 120 outputs the field value of the inputted frame to the field control section 140, and arithmetically calculates a difference described later and outputs this difference to the check sum arithmetic section 130.

The check sum arithmetic section 130 arithmetically calculates a check sum changed correspondingly to the difference arithmetically calculated by the field arithmetic section 120. The field control section 140 determines into which place of the transmission frame the field value outputted from the field arithmetic section 120 and each of various kinds of check sums outputted from the check sum arithmetic section 130 are inserted. The operation of the frame generating section 150 will be described later.

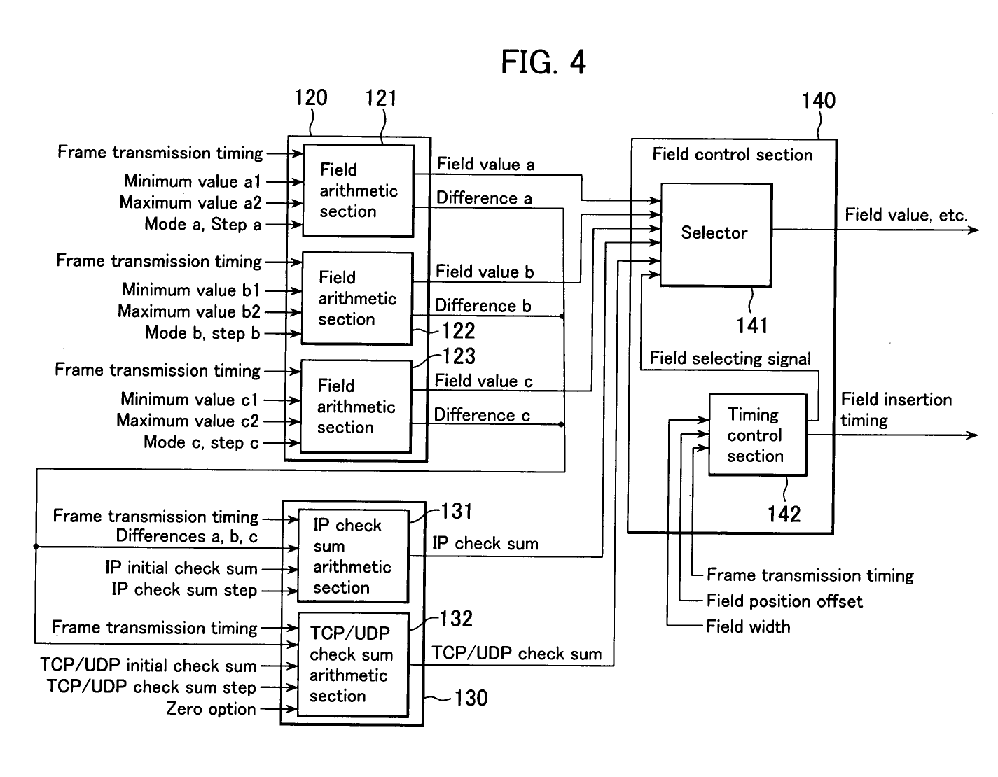

Next, the constructions and operations of the field arithmetic section 120, the check sum arithmetic section 130 and the field control section 140 of FIG. 3 will be explained in detail by using FIG. 4. As shown in FIG. 4, for example, the field arithmetic section 120 has three field arithmetic sections 121 to 123, and arithmetically calculates the field value of the frame. Namely, the field arithmetic section 120 compares an arbitrary field value of the frame and a corresponding field value of a reference frame stored to the memory 110, and calculates the difference between these field values.

Here, the plural field arithmetic sections are arranged to arithmetically calculate different fields of the frame. Accordingly, for example, as shown in FIG. 4, difference a can be outputted by arithmetically calculating the field value of the transmission destination IP address by the field arithmetic section 121, and difference b can be also outputted by arithmetically calculating the MAC address by the field arithmetic section 122.

To correctly arithmetically calculate the check sum, the firmware 200 separately gives instructions about minimum values a1, b1, c1 and maximum values a2, b2, c2 to the respective field arithmetic sections 121, 122, 123 so as not to designate the same field of the frame.

The check sum arithmetic section 130 has an IP header check sum arithmetic section 131 and a TCP/UDP header check sum arithmetic section 132, and arithmetically calculates the check sum changed correspondingly to the difference arithmetically calculated by the field arithmetic section 120. The IP check sum arithmetic section 131 arithmetically calculates the check sum of the IP address, and the TCP/UDP check sum arithmetic section 132 arithmetically calculates the check sum of TCP/UDP.

The field control section 140 has a selector 141 and a timing control section 142, and determines into which place of the transmission frame the field value outputted from the field arithmetic section 120 and the check sum outputted from the check sum arithmetic section 130 are inserted.

Next, the operation of the frame generator of FIG. 4 will be explained. For example, when the field value of a first frame as a base frame inputted to the field arithmetic section 121 is “9” and a field value “14” of a second frame is inputted, the difference is arithmetically calculated as “5”. Here, timing of the arithmetic calculation is set in accordance with frame transmission timing inputted from the frame generator 100. The field arithmetic section 121 then outputs this difference “5” to the check sum arithmetic section 130.

Thus, the field arithmetic section 121 makes the arithmetic calculation with respect to a minimum value a1 to a maximum value a2 of the variable range of the field. A varying method of the field value is selected from increment, decrement and random by mode a, and is particularly varied in accordance with step a as information about a varying step number in the arithmetic calculation using the increment and the decrement. For example, when the mode is set to the increment and the step is set to “1” and the minimum value a1 of the variable range of the field is set to “0” and the maximum value a2 is set to “5”, the field value is arithmetically calculated as 0, 1, 2, 3, 4, 5. When the arithmetic calculation is made by using the field arithmetic sections 122, 123, the arithmetic calculation is made similarly to the case in which the arithmetic calculation is made by using the field arithmetic section 121.

The IP check sum arithmetic section 131 of the check sum arithmetic section 130 arithmetically calculates the check sum by utilizing the difference inputted from the field arithmetic section 121, an initial check sum (which is an IP initial check sum in FIG. 4) inputted from the firmware 200, and a check sum step (which is an IP check sum step in FIG. 4). Hereinafter, the arithmetic calculating method of the check sum will be explained by using a concrete example.

For example, it is supposed that the IP address is varied and the difference a outputted from the field arithmetic section 121 for arithmetically calculating this IP address is “5”. When the IP initial check sum is “9” and the IP check sum step is “1”, the IP check sum arithmetic section 131 makes the following calculation.
IP check sum=9(IP initial check sum)−1(IP check sum step)*5(difference a)=4

Namely, (0110)₂ is calculated by inverting (1001)₂ and (0110)₂+(0101)₂=(1011)₂ is calculated and (0100)₂, i.e., (4)₁₀ is calculated by inverting this (1011)₂.

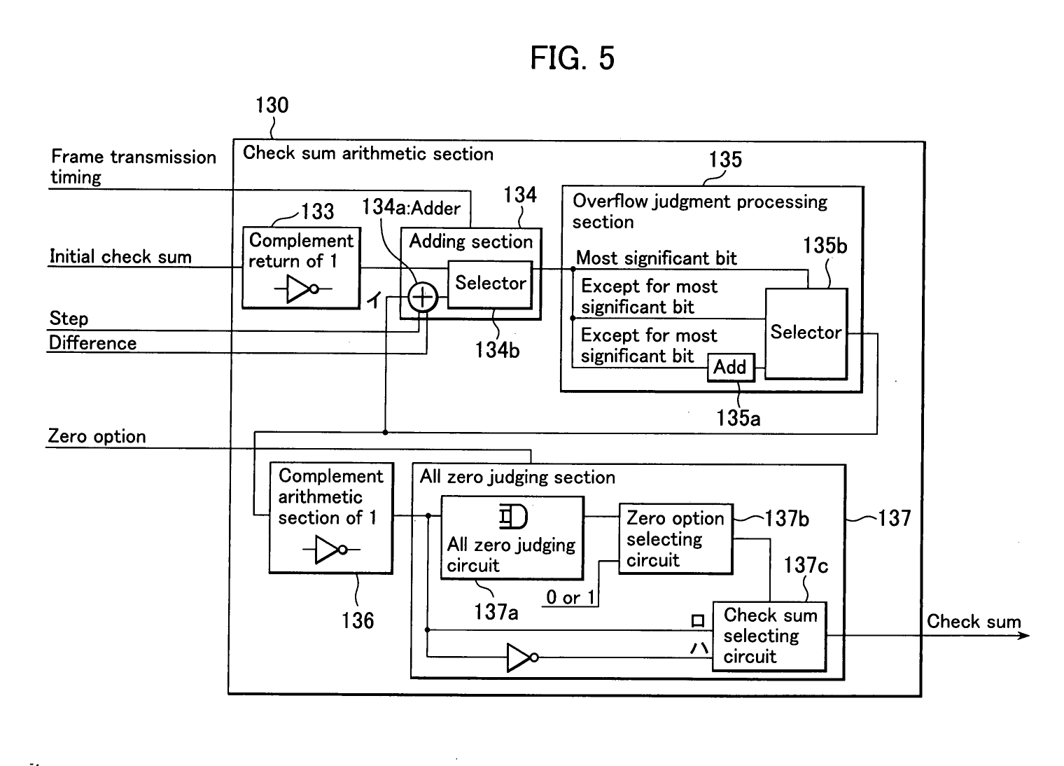

Such a calculating method using the complement of 1 will be described later by using FIG. 5.

The arithmetic calculation using the TCP/UDP check sum arithmetic section 132 is made similarly to the case using the IP check sum arithmetic section 131.

In this case, a zero option is further inputted to the TCP/UDP check sum arithmetic section 132. The zero option is a signal used only when the UDP check sum is calculated. When all bits of the UDP check sum arithmetically calculated by the TCP/UDP check sum arithmetic section 132 are “0”, it is selected whether these bits are inverted to “1” or not.

The bits are inverted because the UDP check sum constructed by “0” in all the bits is not recognized as the check sum and cannot be used. A circuit is communized since TCP and UDP cannot be simultaneously used.

The field value is inputted from the field arithmetic section 121 to the selector 141 of the field control section 140, and the IP check sum is inputted from the IP check sum arithmetic section 131. When the field arithmetic sections 122, 123 and the TCP/UDP check sum arithmetic section 132 are used, field values b, c and the TCP/UDP check sum are inputted to the selector 141.

Frame transmission timing is inputted from the frame generator 100 to the timing control section 142. A field position offset for offsetting the position of the field and a field width as a signal for determining the width of the field are inputted from the firmware 200 to the timing control section 142.

The timing control section 142 outputs a field selecting signal to the selector 141 on the basis of these information, and also outputs field insertion timing to the frame generating section 150 of FIG. 3. The selector 141 selects one of field values a, b, c, the IP check sum or the TCP/UDP check sum (hereinafter also called a “field value”, etc.) on the basis of the field selecting signal, and outputs the selected one to the frame generating section 150 of FIG. 3.

The frame generating section 150 of FIG. 3 inserts the field value, etc. inputted from the selector 141 into the transmission frame in accordance with the field insertion timing inputted from the timing control section 142, and outputs this transmission frame to a network in conformity with the transmission timing inputted from the firmware 200.

The construction and operation of the check sum arithmetic section of FIG. 3 will next be explained in detail with reference to FIG. 5. The check sum arithmetic section 130 has a complement return circuit 133 of 1, an adding section 134, an overflow judgment processing section 135, a complement arithmetic section 136 of 1, and an ALL zero judging section 137. The complement return circuit 133 of 1 returns the check sum value arithmetically calculated with respect to the complement of 1 to the original value, and concretely performs bit inversion of the check sum value.

The adding section 134 has an adder 134a and a selector 134b. The adder 134a adds a check sum calculating value (code I) after overflow judgment processing, a “step” inputted from the firmware, and a “difference” inputted from the field arithmetic section. The selector 134b selects and outputs a signal inputted through the adder 134a.

The overflow judgment processing section 135 has an Add (Addition) 135a and a selector 135b. The Add 135a adds an amount overflowing from the check sum calculating value inputted from the adding section 134. The selector 135b judges whether no check sum calculating value overflows from a most significant bit of the check sum. The selector 135b then selects the check sum value to be outputted.

The complement arithmetic section 136 of 1 takes the complement of 1 of the check sum calculating value. Since it is necessary to take the complement of 1 with respect to the check sum value, the check sum calculating value is concretely bit-inverted.

The ALL zero judging section 137 has an ALL zero judging circuit 137a, a zero option selecting circuit 137b and a check sum selecting circuit 137c. The ALL zero judging circuit 137a judges whether the check sum arithmetic value arithmetically calculated with respect to the complement of 1 is ALL-zero, i.e., all the bits are ‘0’. The zero option selecting circuit 137b is a selector for selecting the check sum to be outputted by the existence of the selection of the zero option when an object check sum inputted from the firmware is a UDP header. The check sum selecting circuit 137c is a selector for selecting the check sum to be outputted on the basis of a signal inputted from the zero option selecting circuit 137b.

The operation of the check sum arithmetic section of FIG. 5 will next be explained. An initial check sum value inputted through the complement return circuit 133 of 1 is inputted to the adding section 134 when the first frame is transmitted in accordance with the frame transmission timing inputted from the firmware.

The selector 134b selects the initial check sum inputted through the complement return circuit 133 of 1 when the inputted frame is the first frame. This initial check sum is outputted to the overflow judgment processing section 135. However, since no initial check sum bit-inverted in the complement return circuit 133 of 1 overflows, this initial check sum passes through the overflow judgment processing section 135 as it is. With respect to the signal passing through the overflow judgment processing section 135, the complement of 1 is taken (i.e., bit-inverted) in the complement arithmetic section 136 of 1, and is outputted to the ALL zero judging section 137.

With respect to the signal inputted to the ALL zero judging section 137, it is judged in the ALL zero judging circuit 137a whether the check sum value is ALL-zero. If the check sum value is ALL-zero, ‘1’ is notified to the zero option selecting circuit 137b. In contrast to this, ‘0’ is notified to the zero option selecting circuit 137b in a case except for the case in which the check sum value is ALL-zero. In this case, the zero option inputted from the firmware is used.

Namely, when the check sum value is set to be converted into ALL1 by the zero option when the object header of the check sum is UDP and the check sum value is ALL-zero, the zero option selecting circuit 137b selects ‘1’ on the basis of the signal inputted from the ALL zero judging circuit 137a.

In contrast to this, the zero option selecting circuit 137b selects “0” when the object header of the check sum is a header except for UDP, or the object header is UDP but the check sum value is set so as not to be converted into ALL1 by the zero option even when the check sum value is ALL-zero. Thus, the signal (i.e., ‘1’ or ‘0’) outputted from the zero option selecting circuit 137b is outputted to the check sum selecting circuit 137c.

Further, the signal inputted through the complement arithmetic section 136 of 1 is inputted to the check sum selecting circuit 137c as it is (code II), and is bit-inverted in logical NOT and is then inputted to the check sum selecting circuit 137c (code III).

The check sum selecting circuit 137c selects the check sum of the signal inputted from the zero option selecting circuit 137b. Namely, when the signal inputted from the zero option selecting circuit 137b shows ‘1’, this case is a selecting case in which the object header is UDP and the check sum is ALL-zero and the zero option is used. Accordingly, the check sum selecting circuit 137c selects the bit-inverted check sum inputted from the complement arithmetic section 136 of 1. Namely, ALL1 is outputted from the check sum selecting circuit 137c.

Further, when the signal shows ‘0’, this case is a case in which the check sum is not ALL-zero or no zero option is used. Accordingly, the check sum (code II) inputted to the check sum selecting circuit 137c as it is is selected and this signal is outputted to the field control section 140 of FIG. 3 as the check sum.

After the second frame, a value provided by adding the “step” inputted from the firmware and the “difference” inputted from the field arithmetic section 120 becomes the check sum value in addition to the check sum calculating value (code I) outputted from the overflow judgment processing section 135 and fed back to the adder 134a. This check sum value is outputted from the adding section 134 to the overflow judgment processing section 135 by the frame transmission timing inputted from the firmware. The overflow judgment processing section 135 judges whether no check sum added by the adding section 134 overflows.

In the check sum added in the adding section 134, a bit for the overflow judgment is added to the most significant bit of the check sum, and its result is outputted to the overflow judgment processing section 135. Accordingly, the overflow judgment processing section 135 judges the overflow on the basis of the most significant bit as this bit for the overflow judgment.

In the overflow judgment processing section 135, the selector 135b outputs the check sum as it is if there is no overflow. In contrast to this, if the overflow is caused, the selector 135b selects and outputs the check sum inputted through the Add 135a. Such an operation is performed because it is determined by a calculation formula of the header check sum that all amounts carried in digit by the check sum arithmetic calculation are added.

The second frame outputted from the overflow judgment processing section 135 is outputted as the check sum similarly to the first frame, and is processed similarly to the case of the first frame, and these operations are thereafter repeated until the processing is terminated.

The invention has been explained by using the constructional example of the frame of IPv4, but protocol ICMPv6 of Internet Protocol Version 6 (IPv6) may be also used.

What is claimed is:

1. A frame generator in which a frame generating section generates a transmission frame and outputs this transmission frame to a network on the basis of a field value of an input frame generated by firmware,
the frame generator comprising:
a memory for storing a reference frame of said transmission frame;
a field arithmetic section for outputting an arbitrary field value of said input frame and comparing this field value and a corresponding field value of said reference frame and calculating the difference between these field values;
a check sum arithmetic section for arithmetically calculating a check sum changed correspondingly to said difference; and
a field control section for inputting said arbitrary field value and said check sum thereto and determining into which place of said transmission frame said arbitrary field value and said check sum are inserted.

2. The frame generator according to claim 1, wherein said check sum arithmetic section has an IP header check sum arithmetic section for inputting said difference between the field value of said input frame and the corresponding field value of said reference frame thereto, and arithmetically calculating the check sum of an IP header address changed correspondingly to this difference by utilizing a first initial check sum inputted from said firmware and a first check sum step for determining a step of this first initial check sum.

3. The frame generator according to claim 1, wherein said check sum arithmetic section has a TCP/UDP/ICMPv6 header check sum arithmetic section for inputting said difference between the field value of said input frame and the corresponding field value of said reference frame thereto, and arithmetically calculating the check sum of a TCP/UDP/ICMPv6 header changed correspondingly to this difference by utilizing a second initial check sum inputted from said firmware and a second check sum step for determining a step of this second initial check sum.

4. The frame generator according to claim 1, wherein a plurality of said field arithmetic sections are arranged.

5. The frame generator according to claim 1, wherein said firmware separately gives the instructions of a minimum value and a maximum value to the plural field arithmetic sections so as not to designate the same field of said input frame.

6. A frame generator for outputting a transmission frame generated on the basis of a field value of an input frame generated by firmware to a network, and testing said network,
wherein a first frame of said transmission frame is set to a reference frame,
an arbitrary field value of said input frame is compared with a corresponding field value of said reference frame and the difference between these field values is calculated,
a check sum caused by said difference is calculated and
it is determined into which place of said transmission frame said arbitrary field value and said check sum are inserted.
